(19) United States
(12) Patent Application Publication
(10) Pub. No.: US 2017/0112239 A1
(43) Pub. Date: Apr. 27, 2017

(54) WATER-WASHABLE MASKING COATING SOLUTION FOR POST-PROCESSING SHOE SOLE AND METHOD FOR USING COATING SOLUTION

(71) Applicant: Heedae Park, Busan (KR)

(72) Inventor: Heedae Park, Busan (KR)

(21) Appl. No.: 14/941,949

(22) Filed: Nov. 16, 2015

(30) Foreign Application Priority Data
Oct. 27, 2015 (KR) 10-2015-0149117

(51) Int. Cl. A43D 11/00; C09D 129/04

(52) U.S. Cl. CPC A43D 11/003; C09D 129/04

(57) ABSTRACT

The present invention is to develop a wet masking coating solution which is used to protect a shoe sole from contaminants and dust generated during a post-processing treatment of the shoe sole, such as laser etching or hot knife. The present invention proposes a water-washable masking coating solution for post-processing a shoe sole which can be perfectly removed just when the masking coating solution dried after post-processing treatment of the shoe sole is washed with water, thereby making consecutive work and mass production possible. Moreover, the present invention proposes a method for using the water-washable masking coating solution.

### REFERENCE TO RELATED APPLICATIONS

This application claims the priority benefit of Korean Patent Application No. 10-2015-0149117 filed on Oct. 27, 2015, the entire contents of which are incorporated herein by reference.

### FIELD OF THE INVENTION

The present invention relates to a water-washable masking coating solution for post-processing a shoe sole and a method for using the coating solution, and more particularly, to a water-washable masking coating solution for post-processing a shoe sole, which is a wet masking coating solution made of polyvinyl alcohol, and a method for using the coating solution, which can easily remove the masking coating solution using water after post-processing the shoe sole coated with the masking coating solution, thereby improving productivity of products because it makes consecutive work and mass production possible.

### BACKGROUND OF THE INVENTION

As well-known, people put on shoes to protect the feet and to walk in the shoes. Such shoes are indispensable to life and there are dozens of kinds of shoes. Moreover, shoes are classified into sneakers, heels, slippers, basketball shoes, soccer shoes, hiking boots, work shoes, military boots, and so on according to uses and functions.

Recently, shoes with various functions to make users wear comfortable and to keep the users healthy have been developed.

Such shoes have soles of various forms, such as an outsole, a midsole and an insole, which are adhered to each other. The outsole which is the floor surface of the shoe comes into contact with the ground and provides an anti-slip function, the midsole is arranged on the outsole to prevent transformation of the shoe and is lightweight and provides a cushioning effect to absorb shock applied to the foot, the sole of the user's foot or joints when the user walks in the shoes. The insole is arranged on the midsole and gets in direct contact with the sole of the user's foot to protect the sole of the user's foot, relax the foot and subsidiarily absorb shock.

In the meantime, the soles are bonded with one another after going through a surface treatment process, such as reforming, or a pretreatment process, such as a surface washing process. Moreover, the shoe sole goes through a post-processing treatment, such as laser etching or hot knife. For instance, as proposed in the following prior art 1, the shoe sole is manufactured to have various shapes of curves. In this instance, the shoe sole goes through the post-processing treatment after being coated with a masking coating solution in order to protect the shoe sole from contaminants and dust.

However, the conventional masking coating solution used to carry out the post-processing treatment to the shoe sole must go through the steps of coating the masking coating solution onto the surface of the shoe sole using a general sprayer, drying the masking coating solution into a gum type, carrying out the post-processing treatment, and removing the gum-type masking coating solution and contaminants with a worker's hand. That is, the worker has to carry out the post-processing treatment to the shoe sole after coating and drying the masking coating solution onto the surface of the shoe sole, and then, remove the solidified gum-type masking coating solution in everything with the worker's hand. However, while removing the gum-type masking coating solution from the shoe sole, contaminants are scattered. Especially, the conventional masking coating solution has several disadvantages in that the surface of the shoe sole becomes dirty because the gum-type masking coating solution stuck to the surface of the shoe sole is not removed well, and in that productivity is remarkably deteriorated because work is not carried out consecutively.

### SUMMARY OF THE INVENTION

Accordingly, the present invention has been made in view of the above-mentioned problems occurring in the prior art, and it is an object of the present invention to provide a water-washable masking coating solution for post-processing a shoe sole and a method for using the coating solution, which can conveniently remove a wet masking coating solution using water after coating and drying the wet masking coating solution on the surface of a shoe sole, thereby making consecutive work and mass production possible.

It is another object of the present invention to provide a water-washable masking coating solution for post-processing a shoe sole and a method for using the coating solution, which can prevent contaminants and dust from being stuck to the surface of the shoe sole, remove the masking coating solution using water, and continuously recycle water by filtering wastewater generated while removing the masking coating solution with water.

To achieve the above objects, the present invention provides a water-washable masking coating solution for post-processing a shoe sole is made by mixing polyvinyl alcohol and water.

Moreover, in another aspect of the present invention, the present invention provides a method for using the coating solution to protect a shoe sole from contaminants and dust when the shoe sole is post-treated, the method including the steps of: manufacturing a masking coating solution by mixing polyvinyl alcohol, which is 80 to 95% mol in degree of saponification, and water; coating the coating solution onto a part of the shoe sole to be post-processed and drying the coated solution; post-processing the shoe sole on which the coating solution is dried through a general method; and washing the post-processed shoe sole with water.

In another aspect of the present invention, the present invention provides a method for using the coating solution to protect a shoe sole from contaminants and dust when the shoe sole is post-treated, the method including the steps of: manufacturing a masking coating solution by mixing polyvinyl alcohol, which is 95 to 99.9% mol in degree of saponification, and water; coating the coating solution onto a part of the shoe sole to be post-processed and drying the coated solution; post-processing the shoe sole on which the coating solution is dried through a general method; washing the post-processed shoe sole with water; and filtering the polyvinyl alcohol, which did not dissolved in water in the washing step, with a general filter to reuse water.

The water-washable masking coating solution according to the present invention can be easily removed using water after going through the post-processing treatment of the shoe sole coated with the masking coating solution and can improve productivity of products because it makes consecutive work and mass production possible.

Additionally, the present invention can enhance post-processing workability of the shoe sole, and especially, prevent environmental pollution because the masking coating solution made of PVA with low solubility can reuse water (wastewater).

### DETAILED DESCRIPTION OF THE INVENTION

Reference will be now made in detail to preferred embodiments of the disclosure with reference to the attached drawings. It will be understood that representative embodiments of the present invention will be proposed in the detailed description in order to achieve the technical objects and that other embodiments proposable in the present invention will be substituted with description of the present invention.

The present invention is to develop a wet masking coating solution which is used to protect a shoe sole from contaminants and dust generated during a post-processing treatment of the shoe sole, such as laser etching or hot knife. The present invention proposes a water-washable masking coating solution for post-processing a shoe sole which can be perfectly removed just when the masking coating solution dried after post-processing treatment of the shoe sole is washed with water, thereby making consecutive work and mass production possible. Moreover, the present invention proposes a method for using the water-washable masking coating solution.

There are two kinds of water-washable masking coating solution: one being polyvinyl alcohol (hereinafter, called “PVA”) with high solubility and the other being PVA with low solubility.

Preferably, the PVA with high solubility is 80 to 95% mol in degree of saponification. So, the PVA with high solubility is a masking coating solution which is perfectly removed when the PVA which is coated and dried on the surface of the shoe sole is washed with water after the post-processing treatment. The PVA with low solubility is 95 to 99.9% mol in degree of saponification. So, the PVA with low solubility is a masking coating solution which is not soluble in water but is moistened and is removed in the form of a film of a solid state when the PVA which is coated and dried on the surface of the shoe sole is washed with water after the post-processing treatment, thereby continuously reusing the water by filtering through a general filter.

Hereinafter, the present invention will be described in detail in accordance with the preferred embodiments, but is not limited by the preferred embodiments.

### Embodiment 1

In the first preferred embodiment of the present invention, the masking coating solution, which is made of PVA with high solubility, out of the water-washable masking coating solutions according to the present invention will be described in detail.

First, mix 1 to 50 wt % of PVA which is 80 to 95% mol in degree of saponification and 50 to 99 wt % of water to manufacture the masking coating solution.

Next, coat the masking coating solution onto the surface of the shoe sole, namely, a part to be post-processed, using a sprayer and dry the coated masking coating solution. After that, carry out the general post-processing treatment, such as laser etching or hot knife, to the shoe sole.

After that, wash off the masking coating solution, which is coated on the surface of the shoe sole in the form of a film, with water so as to easily remove the film layer (masking coating solution) stuck to the shoe sole together with contaminants.

As described above, because the present invention uses water-soluble PVA, preferably, PVA which is 80 to 95% mol in degree of saponification, the masking coating solution coated on the shoe sole can be easily removed together with contaminants and enhance productivity of products due to consecutive work.

### Embodiment 2

In the second preferred embodiment of the present invention, the masking coating solution, which is made of PVA with low solubility, out of the water-washable masking coating solutions according to the present invention will be described in detail.

First, mix 1 to 50 wt % of PVA which is 95 to 99.9% mol in degree of saponification and 50 to 99 wt % of water to manufacture the masking coating solution.

Next, coat the masking coating solution onto the surface of the shoe sole, namely, a part to be post-processed, using a sprayer and dry the coated masking coating solution. After that, carry out the general post-processing treatment, such as laser etching or hot knife, to the shoe sole. After that, remove the masking coating solution, which is coated on the surface of the shoe sole in the form of a film, with water. In this instance, because the film layer (masking coating solution) which is stuck to the shoe sole floats on the water because being PVA which does not dissolve well in water, the water (wastewater) can be recycled and reused when being filtered using a general filter.

As described above, because the present invention uses PVA with low solubility, when the masking coating solution coated on the shoe sole is removed through physical shock, the coating solution floats on the water in the form of the film and the water (wastewater) is filtered to be continuously recycled. Therefore, the masking coating solution according to the second preferred embodiment can prevent environmental pollution better than that according to the first preferred embodiment.

Hereinafter, results of a filtering test of the water-washable masking coating solutions manufactured through the methods according to the first and second preferred embodiments of the present invention will be described in detail.

### 1. Filtering Test Method

1) Respectively manufacture the masking coating solution made of soluble PVA and the masking coating solution made of insoluble PVA through the methods according to the first and second preferred embodiments of the present invention.

2) Coat the two kinds of the masking coating solutions onto eight shoe soles using a sprayer, and dry them at about 50° C. for ten minutes.

3) Wash the dried specimens in water of 4 kg at temperature of 55±5° C.

4) Measure PVA solids in the water.

5) Pass washing water through a 150 mesh filter and measure the PVA solids.

6) Measure weight of the solids before and after filtering to measure a filtration rate.

7) For the test, the masking coating solutions of about 6 g were coated on 1,250 shoe soles per hour in water of 1 ton in a washing tub, and then, the test was carried out on the assumption of concentration generated while washing.

### 2. Results of Filtering Test

TABLE 1

| | | Measurement of solids | | | |
|---|---|---|---|---|---|
| | | Weight | Weight | | |
| Division | | (g) | (g) | Sol- | Filtra- |
| Product | Related with | before | after | ids | tion |
| name | filter | filtration | filtration | (5) | rate |
| Soluble PVA | Before | 15.19 | 0.015 | 0.099 | 0.0 |
| application | filtration | | | | |
| | 150 mesh × 2 | 15.28 | 0.015 | 0.098 | 0.6 |
| | folds | | | | |
| Insoluble PVA | Before | 15.16 | 0.01 | 0.066 | 0.0 |
| application | filtration | | | | |
| | 150 mesh × 2 | 15.19 | 0.005 | 0.033 | 50.1 |
| | folds | | | | |

As shown in the table 1, in case of the masking coating solution made of soluble PVA, residues were not observed after washing, and the solid contents before and after filtration were measured almost identically. Furthermore, in case of the masking coating solution made of insoluble PVA, residues were generated after washing, and just about 50% of the residues were filtered.

1. A water-washable masking coating solution for post-processing a shoe sole consisting of polyvinyl alcohol.

2. The water-washable masking coating solution according to claim 1, wherein the polyvinyl alcohol is 80 to 95% mol in degree of saponification.

3. The water-washable masking coating solution according to claim 1, wherein the polyvinyl alcohol is 95 to 99.9% mol in degree of saponification.

4. The water-washable masking coating solution according to claim 1, wherein the polyvinyl alcohol is mixed with water.

5. The water-washable masking coating solution according to claim 4, consisting of 1 to 50 wt % of polyvinyl alcohol and 50 to 99 wt % of water.

6. A method for using a masking coating solution to protect a shoe sole from contaminants and dust when the shoe sole is post-treated, the method comprising the steps of:
manufacturing a masking coating solution by mixing polyvinyl alcohol, which is 80 to 95% mol in degree of saponification, and water;
coating the coating solution onto a part of the shoe sole to be post-processed and drying the coated solution;
post-processing the shoe sole on which the coating solution is dried through a general method; and
washing the post-processed shoe sole with water.

7. A method for using a masking coating solution to protect a shoe sole from contaminants and dust when the shoe sole is post-treated, the method comprising the steps of:
manufacturing a masking coating solution by mixing polyvinyl alcohol, which is 95 to 99.9% mol in degree of saponification, and water;
coating the coating solution onto a part of the shoe sole to be post-processed and drying the coated solution;
post-processing the shoe sole on which the coating solution is dried through a general method;
washing the post-processed shoe sole with water; and
filtering the polyvinyl alcohol, which did not dissolved in water in the washing step, with a general filter to reuse water.
